(19) United States
(12) Patent Application Publication
(10) Pub. No.: US 2007/0128304 A1
(43) Pub. Date: Jun. 7, 2007

(54) Process and apparatus for green body extrusion

(75) Inventors: Henrik Stang, Naerum (DK); Helge Fredslund-Hansen, Rodovre (DK); Johan Christian Gregersen, Bagsvaerd (DK)

Correspondence Address: NORRIS, MCLAUGHLIN & MARCUS, 875 THIRD AVE, 18TH FLOOR, NEW YORK, NY, 10022, US

(73) Assignee: 3H INVENTORS APS, Naerum (DK)

(21) Appl. No.: 10/595,833

(22) PCT Filed: Nov. 17, 2004
(86) PCT No.: PCT/DK04/00790

§ 371 Date: May 15, 2006

(30) Foreign Application Priority Data
Nov. 19, 2003 (AU) 2003906379

(51) Int. Cl. B28B 1/26; B28B 1/08; B29C 47/00

(52) U.S. Cl. 425/84; 264/70; 264/108; 264/176.1

(57) ABSTRACT

In a process and apparatus for the extrusion of a green body from a paste or suspension of particulate material in a liquid, the suspension is supplied to and substantially fills an extrusion chamber at a relatively low pressure. A high pressure is applied to the suspension on completion of filling whereby the suspension is forced through a moulding spaced with a dewatering section defined by at least partially liquid-permeable walls. A substantial part of the liquid is removed by establishing a pressure differential across at least parts of the wall that are permeable to said liquid, to form a non-flowable shaped body of the particulate material.

### FIELD OF THE INVENTION

The present invention relates to a process and apparatus for extrusion of a green body from a paste or suspension of particulate material (hereinafter referred to collectively as a “suspension”). The process involves removal of liquid from the suspension in the course of extrusion and this removal is hereinafter referred to as “de-watering”. However, de-watering is to be understood as covering removal of any suitable liquid from the particulate material of the suspension, whether or not the liquid is water.

### BACKGROUND TO THE INVENTION

There are two basic, conventional extruder types for extrusion of a suspension. These are ram and screw conveying extruders which respectively operate batch-wise or continuously. In each case the down-stream end of the extruder consists of a die with a die entry and a die land. The die entry shapes the extrudate to the desired cross-sectional shape and further provides a cross-sectional reduction to allow the shaping process to take place under a certain suitable pressure.

The ram extruder operates with a predetermined amount of material of the suspension, which is pressurized in a feed chamber by a piston. The feed chamber leads to the die, which shapes the material as it is extruded in passing through the die. The extrusion pressure is determined by the resistance exerted by the die on the extrudate. That is, the extrusion pressure is determined by the rheological properties of the extrudate in combination with the extrusion speed.

The screw conveying extruder utilises a screw in a housing rather than a ram. The housing is connected to the feed chamber in such a way that material of the suspension continuously can be brought under pressure and fed to the die by the screw. This process only works if the resistance to material flow backwards through the screw is greater than the resistance to material flow through the die. If this condition is fulfilled, the situation is the same as for the ram extruder in that the extrusion pressure is determined by the resistance exerted by the die on the extrudate. That is, the extrusion pressure again is determined by the rheological properties of the extrudate in combination with the extrusion speed. As we shall see in the following this principle causes fundamental problems when extruding thin-walled cementitious products.

Thus, in each case, the rheological parameters of the extrudate, that is the suspension, play a major role in the extrusion process. The rheological parameters of a suspension can be described taking either multi-phase or single-phase models as a starting point. The suspension is more easily understood, and adequately described in the present context, if a so-called single-phase model is used to describe the multi-phase suspension. In a single-phase model one constitutive relationship is used to describe the rheological behavior of the suspension. The rheological parameters of this theoretical single-phase material are thought of as generalized parameters implicitly reflecting the characteristics of the suspension. The relevant characteristics are the particle size distribution, the size of the particles, the surface characteristics of the particles, the volume concentration of the particles and the rheological parameters of the liquid in which the particles are present in the suspension.

A number of single-phase constitutive relationships have been suggested for various types of suspensions, all characterized by the fact that they are non-linear or non-Newtonian and visco-plastic. That is, it is assumed that a certain yield stress has to be overcome in order to deform the solid and once it is deforming, it is highly viscous. This applies in the relationships proposed by Bingham, Herschel-Bulkley and Casson just to mention a few, the simplest being the Bingham-plastic relationship:
τ=τ₀+μγ
where τ is shear stress, τ₀ is yield stress, μ is viscosity and γ is shear strain rate. In a plot of the linear relationship of τ versus γ, the value of the viscosity μ is the slope of the resultant line, while τ₀ is the cut-off on the τ-axis.

As indicated above, in a single-phase model, both the yield stress and the viscosity are functions of the various phases of the suspension in question, namely, the liquid (often water) and the particles. The viscosity of the liquid influences the viscosity of the suspension, and the packing, surface characteristics and particle size distribution of the particles influence the yield stress as well as the viscosity.

The visco-plastic properties of the suspension are subjected to conflicting demands of the extrusion process. Dimensional stability of the extrudate primarily requires a high yield stress (but also high viscosity, if the post processing is slow, the post processing being drying, chemical reactions, or similar processes). From the point of view of facilitating the flow through the die, the yield stress should be limited in order to prevent formation of static zones and to limit the extrusion pressure, while the viscosity of the suspension should be as low as possible to lubricate the process, and to limit extrusion pressure. Finally, the viscosity of the liquid should be high (and thus giving rise to high viscosity of the suspension) in order to prevent large-scale phase migration or separation by movement of the liquid phase relative to the solid particles.

From the point of view of flow through the die, extrusion of cementitious materials has proven to be particularly difficult due to the high inter-particle friction, the disastrous effect of static zones due to setting and hydration and ease of phase migration or separation. The relatively high self-weight of the material puts high demands on the yield stress in order to maintain dimensional stability of the extrudate, which further complicates the flow in the extruder. Consequently, the extrusion of thin-walled cementitious large-scale elements has not been possible until the discovery of a de-watering extrusion principle, which enables the contradictory requirements on yield stress to be resolved.

In de-watering extrusion, the contradictory requirements on yield stress, can be eliminated by causing the suspension to undergo a phase transition during extrusion, from a suspension to a solid, by allowing de-watering under high pressure. This is facilitated by introducing an additional feature into the die comprising a de-watering section where the suspension is de-watered and the particles consolidated by being pressed together to form a solid with a yield stress of several orders of magnitude higher than any suspension. With an extruder having a de-watering section, the yield stress of the suspension can be maintained as low as desired.

Due to the high yield stress of the consolidated extrudate in the de-watering extruder, the extrudate no longer flows through the down-stream end of the die, but is transported as a rigid mass, such as by means of a relative reciprocating movement between inner and outer parts of the die. This gives rise to a fundamental difference between the de-watering extruder and either of the ram and screw type of extruder. On the one hand, in the de-watering extruder, the extrusion pressure can be chosen independently of the resistance (pressure drops) experienced by the extrudate passing through the die entry. On the other hand, in the de-watering extruder there is one pressure drop experienced due to the flow of the extrudate through the die entry (which should be kept as low as possible) and another experienced through the de-watering section and frictional section of the die land (which should be kept as high as possible to facilitate the de-watering process). In traditional ram or screw extruders, on the other hand, the extrusion pressure is determined solely from the passing of the extrudate through the die entry.

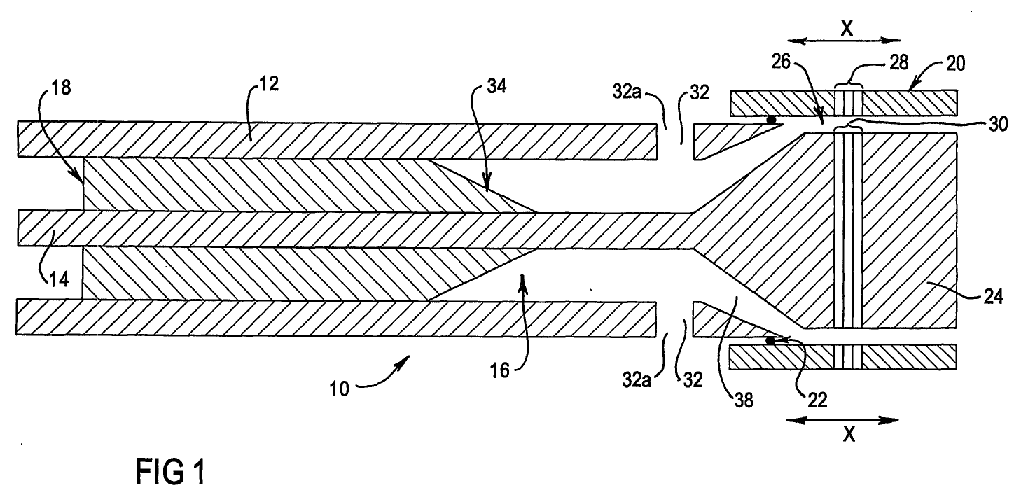

The U.S. Pat. No. 6,398,998 (Krenchel et al.), and its counterpart in EP 0768941, describes a method and apparatus for production of shaped bodies made from particulate material, by what is herein referred to as “de-watering extrusion”. The method and apparatus are illustrated by FIG. 1 of Krenchel et al., which shows a generic extruder with a circular cross section for pipe extrusion. The extruder of FIG. 1 of Krenchel et al. consists of four sections. These are an inlet section A for the supply of flow-able suspension to be compacted leading into a flow section B in which the suspension flows forward. Section B leads to a drainage and consolidation section C (where the walls of the outer and possibly also the inner mold are perforated) which is followed by a solid friction section D. The de-watering and consolidation is described as taking place gradually, due to a high hydrostatic pressure reigning in the flow section B and in at least the adjacent part of the drainage and consolidation section C.

In Krenchel et al. it is indicated that the steps of introducing the suspension into the complete molding space, and removing at least a major portion of the liquid by establishing a pressure differential across the liquid permeable wall of the drainage and consolidation section C, are carried out such that the method commences as a high-pressure slurry pumping process and terminates as a powder-pressing process. The suspension consists of a homogeneous mix of liquid and solid dry matter having a surplus of liquid and having a consistency ranging from a thin slurry to a thick paste, such as with a liquid/dry matter ratio of 1:1 by weight.

In Krenchel et al., it is further indicated that the mixing process may be carried out in a known manner per se. This can involve using a high-performance mixer producing a paste-like suspension with the desired flowability, for supply to the inlet section A of the extruder by means of a high-pressure pump. The introduction of the suspension and its de-watering are described as steps carried out by pumping the slurry into a closed mould with a finely perforated, liquid permeable wall and applying a sufficiently high pressure to the suspension in the mould to establish a pressure differential over the perforated wall from the suspension to the outside of the order of 20-400 bar, preferably 50-200 bar, more preferably 50-100 bar.

Krenchel et al does not touch on a practical solution to the problem of establishing the high pressure in the flowing suspension inside the molding space, except it is mentioned that the concept of high-pressure pumping characterizes the first part of the (continuous) process. A practical solution to the problem, is presented by Stang et al. (1999) “Extrusion of ECC-Material”, in High Performance Fiber Reinforced Cement Composites (HPFRCC3) Edited by Naaman & Reinhardt (RILEM Publications). In Stang et al., there is described a laboratory extruder which works according to the principles described in Krenchel et al. The molding space and extrusion chamber of the laboratory extruder are one and the same thing, consisting of an outer cylinder and an internal core, which leaves an annular shaped molding space between the core and outer cylinder. The moulding space is closed at the rear end, by a seal between the core and the cylinder of the extruder. Consolidation pressure is applied to the suspension by a feed piston in a feed cylinder, which communicates with the rear end of the extrusion chamber, with the feed cylinder axis perpendicular to the extrusion chamber axis. The pressurized suspension is let into the extrusion chamber from the feed cylinder through an inlet to the extrusion chamber, which is open at all times. The consolidation (or de-watering) pressure can be controlled by an actuator, which controls the feed piston. During the extrusion process the pressurized suspension flows from the feed cylinder into the annular shaped extrusion chamber. Thus the suspension material is shaped between the core and the outer cylinder of the extrusion chamber, and it flows towards the de-watering section without further changes in dimensions. In the laboratory extruder the pressurizing cylinder has to be filled, and during this the process is stopped.

We have found that the feed cylinder of Stang et al. can be supplemented by another feed cylinder or replaced by a high-pressure pump enabling continuous extrusion. However, problems occur when using an extrusion machine designed according to the laboratory extruder principle of Stang et al. in continuous production. The most serious problem is that of pre-consolidation, i.e. internal de-watering of the suspension at locations other than at the de-watering section of the extruder. The origin of this problem is that there is always a risk of de-watering taking place when the suspension is subjected to a pressure gradient. At the de-watering section (where de-watering is intended to take place) the suspension is subjected to the pressure gradient existing over the perforated wall, i.e. the difference between the atmospheric pressure and the suspension pressure. The small size of the perforation prevent the passage of solid particles, but water is squeezed out and de-watering is enforced.

However, even without the hindered movement of the solid particles de-watering can take place: if the boundary conditions allow, a certain prescribed pressure drop over the suspension will give rise to a certain flow rate. Since a cementitious suspension is a multi-phase material (liquid and a number of different particles and possibly fibers) this flow can be realized in at least two different ways: suspension (or continuum) flow or water flow between the particles, the latter flow mode being the one previously referred to as phase migration or separation. Another way phase migration can be realized is water and part of the particles flowing between the rest of the particles. The flow mode with least resistance will be the dominating flow mode. Any flow mode other than suspension (or continuum) flow is called phase migration or separation. A suspension, with a high resistance to separation under given conditions is called a stable suspension while a suspension which easily separates is called an unstable suspension. Once phase separation as started, it is usually an irreversible process. The separation gives rise to a static zone with a higher concentration of particles, and, hence, with a higher yield stress. This makes it even harder to remove the static material, which will continue to de-water and possibly grow until completely pre-consolidated material is formed.

In the extruder, pressure differentials will always exist is the flow direction due to friction, flow around corners and cross sectional changes in the flow path. Further, since a cementitious suspension in terms of flow properties behaves like a Bingham plastic material (and not as a Newtonian liquid) a certain shear stress has to be present in the suspension in order to make the suspension flow. This means that there is a potential danger that not all the suspension flows in the extruder chamber and, hence, static zones can be created. Due to pressure differentials there will exist dead spots, which will tend to de-water and grow.

The extruder of Stang et al. gives rise to problems with pre-consolidation, which makes it unsuitable for industrial production. At the inlet, the flow pattern of suspension through the inlet and around the core is such that dead-spots occur. The flow at which dead spots are created takes place at high pressure. Thus, a significant amount of de-watering will take place at these dead spots, and eventually the flow paths will be blocked and the de-watered material will start to hydrate. The problem cannot be overcome with simple parametric variations. Decreasing the applied suspension consolidation pressure will decrease the de-watering rate at the de-watering section, thus decreasing the extrusion rate below what is required in an industrial extruder (for example about 1 m of extrudate per min.). Also, increasing the stability of the suspension (changing particle size and water viscosity) would slow down or hinder the development of de-watered dead-spots but this would also slow down extrusion, because the de-watering at the de-watering section works according to the same principles as at the dead-spots.

### BRIEF SUMMARY OF THE INVENTION

The present invention seeks to provide a process and apparatus enabling green body extrusion by de-watering a paste or suspension of particulate material, which facilitates operation under high pressure and thereby enables practical production rates. The process is called in-line, dewatering extrusion and the corresponding apparatus is called an in-line dewatering extruder.
We have found that in de-watering extrusion of a suspension to produce a green body extrusion, there are some fundamental relationships, which govern suspension stability and the risk of de-watering/separation. We have found that the rate of de-watering in a given situation is approximately proportional to the pressure differential.

According to the present invention, there is provided a process for the extrusion of a green body from a paste or suspension of particulate material in a liquid (herein referred to collectively as a “suspension”), wherein the process includes the steps of:
(a) supplying the suspension to and substantially filling an extrusion chamber at a relatively low pressure;
(b) applying a substantially higher pressure to the suspension on completion of step (a) whereby the suspension is forced from the extrusion chamber and through a moulding spaced with a dewatering section defined by at least partially liquid-permeable walls; and
(c) removing a substantial part of the liquid by establishing a pressure differential across at least parts of said wall that are permeable to said liquid to form a non-flowable shaped body of said particulate material to bring dewatered paste to a final shape for the green body.

In the process of the invention, the concept of a continuous process is abandoned and the low pressure filling of the extrusion chamber is separated from the high pressure extrusion of the suspension. Extrusion pressure sufficient to establish industrial scale extrusion rates is thereby facilitated. Filling of the extrusion chamber is done at low pressure such as below 20 bar, preferably below 10 bar.

The application of a substantially higher pressure to force the suspension from the extrusion chamber and into the moulding space is done at a pressure of at least 80 bar, such as from 80 to 240 bar, more preferably from 100 to 180 bar and most preferably about 150 bar.

The extrusion chamber has the same principle cross sectional geometry or form as the final product and it most preferably is pressurized using a piston with the same cross sectional geometry as the final product (and fitting into the extrusion chamber). In the process, the suspension may experience only cross sectional reductions in its flow through the extrusion chamber towards the de-watering sections, enabling the formation of dead spots to be prevented. In this case, the cross sectional area of the extrusion chamber is larger than the cross-section of the extruded body. The cross section reduction may be between 1:2 and 1:10, preferably between 1:3 and 1:6.

In order to further minimise the risk of pre-consolidation, an inlet port or each inlet port to the extrusion chamber is placed at or close to the end of the extrusion chamber through which the suspension is forced during the extrusion of step (b). Thus, the inlet port or each inlet port may be located where the piston head is positioned on completion of an extrusion stroke and emptying of the extrusion chamber.

Further, the piston head may have a leading face, by which high pressure is applied to the suspension in step (b), which is inclined with respect to the line of movement of the piston. The inclination preferably is such that, on completion of a full extrusion stroke of the piston head, a flow of suspension for filling the extrusion chamber in step (a) for the next stroke, or part of a stroke, cleans the leading face of the piston. Also, the filling of the extrusion chamber in each step (a) can cause or assist in movement of the piston to its retracted position.

In a preferred form, the process of the invention (in-line de-watering extrusion) includes the steps of:
(a) supplying the suspension to and substantially filling an extrusion chamber at a relatively low pressure below 20 bar, preferably below 10 bar;
(b) applying a substantially higher pressure in excess of 80 bar, such as from 80 to 240 bar, to the suspension on completion of step (a) whereby the suspension is forced through a moulding spaced with at least partially liquid-permeable walls; and
(c) removing a substantial part of the liquid by establishing a pressure differential across at least parts of said wall that are permeable to said liquid to form a non-flowable shaped body of said particulate material;
   wherein the body has a reduced cross-section relative to the extrusion chamber of between 1:2 to 1:10, preferably between 1:3 to 1:6.

The invention also provides an apparatus (in-line de-watering extruder) for use in the extrusion of a green body from a paste or suspension of particulate material in a liquid (herein referred to collectively as a “suspension”), wherein the apparatus includes:
an extrusion chamber,
a moulding space with a dewatering section defined by at least partially liquid-permeable walls;
means for supplying the suspension to and substantially filling the extrusion chamber at a relatively low pressure; and
means for applying a high pressure to suspension in the extrusion chamber and forcing the suspension from the extrusion chamber and through the moulding space, and thereby remove a substantial part of the liquid by establishing a pressure differential across at least parts of said wall permeable to said liquid to form a non-flowable shaped body of said particulate material and bring the dewatered paste to a final shape for the green body.

In order that the invention may more readily be understood, description is directed to the accompanying drawings, in which:

FIG. 1 is a vertical sectional view through apparatus according to the present invention; and

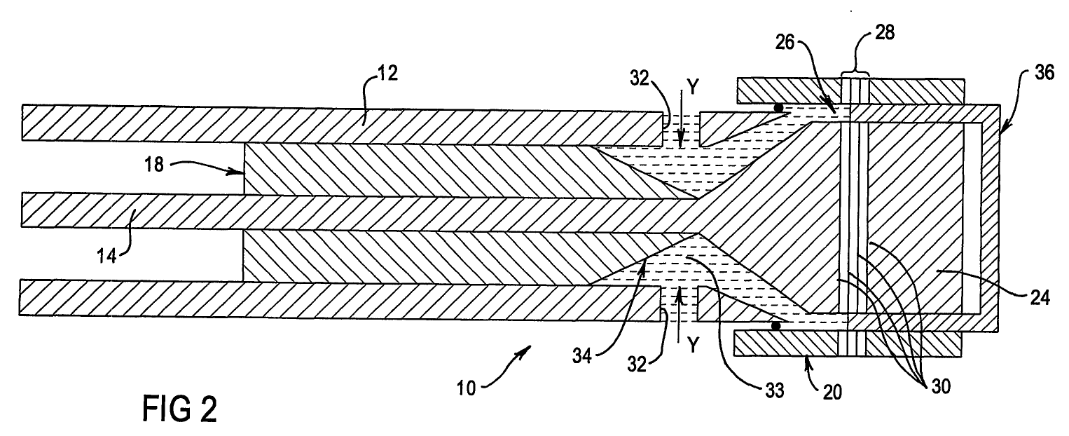

FIGS. 2 to 5 correspond to FIG. 1, but illustrate the apparatus in respective conditions in the course of an extrusion cycle.

FIGS. 2 to 5 show the same components of apparatus 10 of FIG. 1. Thus, the same reference numeral denotes the same component in each of FIGS. 1 to 5.

The apparatus 10 is of a form suitable for producing a cylindrical green body of a cementitious suspension, suitable for curing to produce an extruded concrete pipe. The apparatus 10 thus has a circular form in cross-section, although other arrangements are possible for the extrusion of products of other cross-sectional shape.

With reference to FIG. 1, the apparatus 10 has an outer cylindrical part or housing 12 within which an inner part or mandrel 14 is disposed. An extrusion chamber 16 of annular form is defined within housing 12, around mandrel 14. An annular piston 18 is slidable in housing 12, along mandrel 14. The means by which mandrel 14 is mounted in housing 12 has not been shown, for simplicity of illustration while, except as detailed later herein, means for longitudinally moving piston 18 has similarly been omitted. However, in the orientation shown in each Figure, piston 18 is advanced to the right during an extrusion stroke for apparatus 10, and thereafter is moved rearwardly in readiness for the next stroke.

At its forward end, to the right in FIG. 1, apparatus 10 has a sleeve 20 which is concentric with the forward end of housing 12. The sleeve 20 is longitudinally reciprocable, as represented by the arrow “X”. A forward end margin of housing 12 is within sleeve 20 and a seal 22 is provided therebetween. Beyond the forward end of housing 12, but concentrically within sleeve 20, mandrel 14 has an enlarged head portion 24. An annular moulding space 26, with which chamber 16 is in communication, is defined by sleeve 20 and mandrel head portion 24. Each of sleeve 20 and portion 24 comprises a peripheral wall, which is liquid-permeable. The permeability is provided by a respective plurality of nozzles or slots 28 and 30, such as of a form such as described in U.S. Pat. No. 6,398,998 to Krenchel et al.

Adjacent to a tapered transition of mandrel 14 leading to head portion 24, housing 12 defines inlet ports 32 which communicate with extrusion chamber 16, a short distance from moulding space 26. While not shown, each port 32 is connected to a passage through which an aqueous, cementitious suspension 33 (see FIGS. 2 to 5) is able to be supplied from a suitable, relatively low pressure source.

On commencement of a cycle of operation, piston 18 is at an extreme position to the right, shown in FIG. 2, so that its leading end face 34 is adjacent to inlet ports 32. With piston 18 in that position, extrusion chamber 16 is at a minimum volume. As shown, face 34 is inclined with respect to the line of movement of piston 18. Indeed, as piston is annular, face 34 has a frusto-conical form tapering down in the extrusion direction, to the right in the orientation illustrated. The arrangement is such that, as suspension 33 is supplied into extrusion chamber 16, via ports 32, as depicted by arrows Y in FIG. 2, it sweeps around and cleans face 34 by displacing any consolidated particulate material.

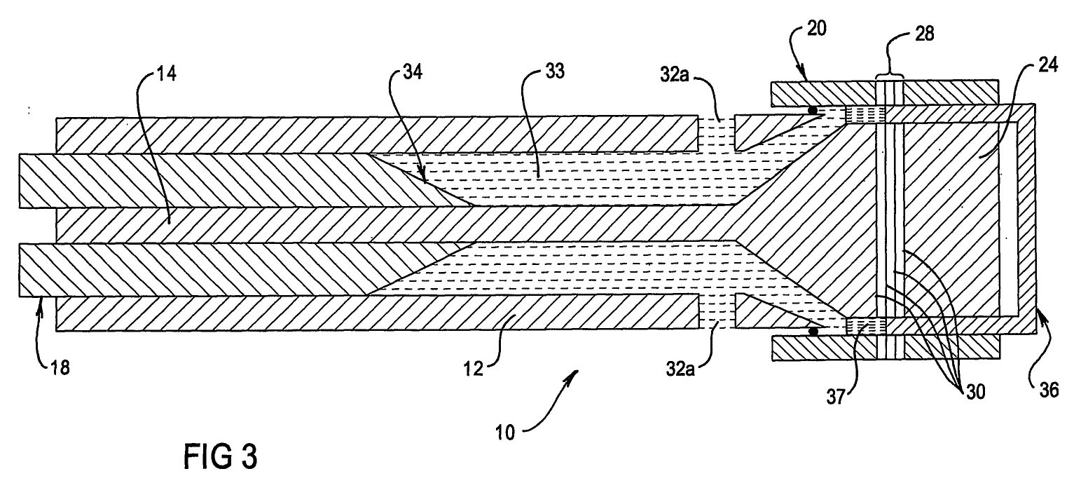

Prior to suspension 33 being supplied to chamber 16, it is necessary to close the forward, outlet end of apparatus 10. For this, as shown in FIG. 2, a cap 36 such as of steel is fitted and secured at that end, such as under hydraulic pressure. With cap 36 positioned, the suspension 33 is supplied under relatively low pressure through ports 32, into extrusion chamber 16. The suspension 33 may be at a pressure below 20 bar, and preferably below 10 bar. Despite such low pressure, the suspension 33 can cause or contribute to piston 18 being moved rearwardly or it is moved by suitable means such as an hydraulic actuator, to its extreme position to the left in the orientation illustrated, as shown in FIG. 3. At this stage, chamber 16 is fully supplied with suspension 33 and apparatus 10 is ready for commencement of an extrusion step. The first stage of that step is to close inlet ports 32 against the egress of suspension 33, although the means for this is not shown other than schematically at 32a for each port 32. For extrusion, high pressure is applied to piston 18 and, hence, to suspension 33 in chamber 16, as piston 18 is driven to the right.

The high pressure may be applied to piston 18 by any suitable means. With application of that pressure, suspension 33 is forced from extrusion chamber 16, through a tapering passage 38 between housing 12 and mandrel head portion 24, and into mould space 26. From the main part of chamber 16 to space 26, the cross-sectional form of the volume in which the suspension is contained and moved is substantially the same, in this instance annular. However, the area in which the suspension 33 is caused to move preferably decreases, most preferably progressively, in the extrusion direction. This decrease may be such that the ratio of the cross-sectional area of space 26 to the maximum cross-sectional area of chamber 16 is in the range of from 1:2 to 1:10, preferably from 1:3 to 1:6. Thus, there is little if any scope for dead spots to develop or for de-watering of the suspension 33 to occur in advance of the suspension 33 entering space 26.

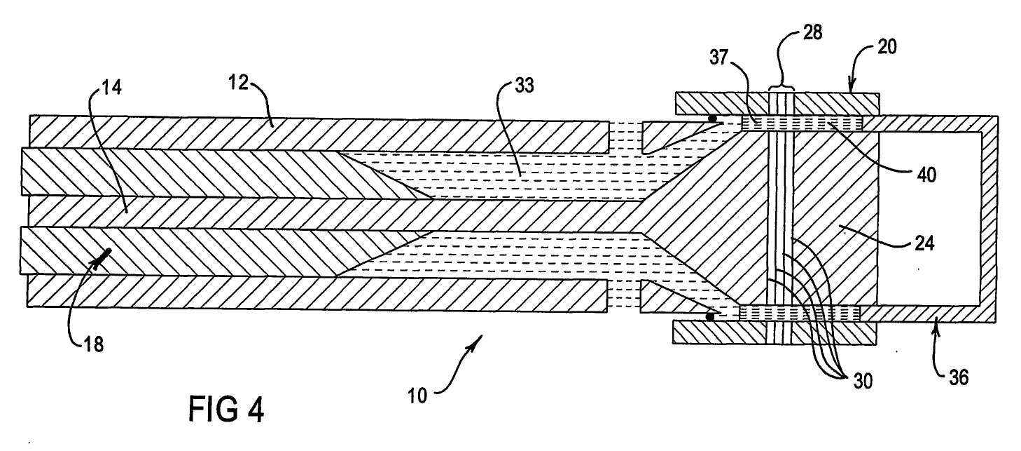

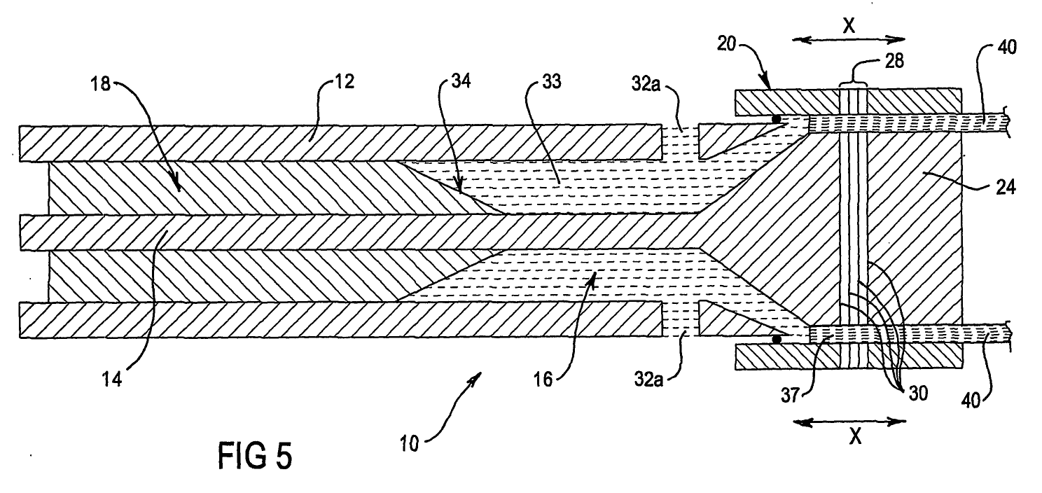

Within mould space 26, the suspension 33 is progressively de-watered under the influence of the pressure differential across the nozzles or slots 28 and also the nozzles or slots 30. In each case the differential exists due the pressure applied to the suspension 33 by piston 18 and the ambient pressure prevailing outside sleeve 20 and within the wall defining mandrel head portion 24. Thus, a non-flowable, annular shaped body 37 of particulate material is built in mould space 26. Retention of cap 36 assists in initiating formation of that body 37. In the manner described in the above-mentioned US patent to Krenchel et al, the non-flowable body 37 is able to advance from apparatus 10, as an extruded green body, as further suspension 33 is forced into and de-watered in mould space 26, and by periodic reciprocation of sleeve 20 to reduce friction forces acting to retard movement of the non-flowable body 37. During an initial stage of the non-flowable body advancing, cap 36 is withdrawn progressively to provide a back pressure assisting in stabilising that body. However, after extrusion of a relatively short length of extrudate or green body 40 (see FIGS. 4 and 5), comprising the non-flowable body once it has advanced beyond nozzles or slots 28 and 30, cap 36 is able to be removed from the forward, outlet end of apparatus 10. This enables the extruded green body 40 to advance beyond that end of apparatus 10.

As will be appreciated, the schematic nature of FIGS. 1 to 5 is such that components are depicted only as they appear in the plane of each drawing. However, the whole system, in the arrangement illustrated, is of circular and/or annular form. Thus, housing 12 and sleeve 20 each is cylindrical, while chamber 16, passage 38 and mould space 26 each is of annular form. Thus, non-flowable body 37 and green body 40 each is of cylindrical form, with body 40 being extrudable to a length suitable for use as an extruded cementitious pipe.

The process and extruder of the present invention applies to all thin walled cross sectional shapes and any closed thin-walled sections including but not limited to circular, rectangular and triangular shapes. Further the invention applies to solid, thin walled cross sections, including but not limited to flat and corrugated plates.

The extrusion materials relevant for the present invention are suspensions including but not limited to cementitious materials and fiber reinforced cementitious materials, including such materials based on Portland cement.

Finally, it is to be understood that various alterations, modifications and/or additions may be introduced into the constructions and arrangements of parts previously described without departing from the spirit or ambit of the invention.

1. A process for the extrusion of a green body from a paste or suspension of particulate material in a liquid (herein referred to collectively as a “suspension”), wherein the process includes the steps of:
(a) supplying the suspension to and substantially filling an extrusion chamber at a relatively low pressure;
(b) applying a substantially higher pressure to the suspension on completion of step (a) whereby the suspension is forced from the extrusion chamber and through a moulding spaced with a dewatering section defined by at least partially liquid-permeable walls; and
(c) removing a substantial part of the liquid by establishing a pressure differential across at least parts of said wall that are permeable to said liquid to form a non-flowable shaped body of said particulate material to bring dewatered paste to a final shape for the green body.

2. The process of claim 1, wherein the extrusion chamber has substantially the same principle cross sectional geometry or form as the final product and is pressurized using a piston with the same cross sectional geometry as the final product and fitting into the extrusion chamber.

3. The process of claim 1 or claim 2, wherein the suspension experiences substantially only cross sectional reductions in its flow through the extrusion chamber towards the de-watering section, whereby the formation of dead spots is substantially prevented; and wherein the cross sectional area of the extrusion chamber is larger than the cross-section of the extruded body.

4. The process of claim 3, wherein the suspension undergoes a cross section reduction of between 1:2 and 1:10.

5. The process of claim 4, wherein the reduction is from 1:3 and 1:6

6. The process of any one of claims 1 to 5, wherein supplying the suspension in step (a) is through at least one inlet port to the extrusion chamber placed at or close to the end of the extrusion chamber through which the suspension is forced during the extrusion of step (b).

7. The process of claim 2, wherein supplying the suspension in step (a) is through at least one inlet port located where the piston head is positioned on completion of an extrusion stroke and emptying of the extrusion chamber.

8. The process of claim 7, wherein high pressure is applied to the suspension in step (b) by a leading face of the piston head which is inclined with respect to the line of movement of the piston.

9. The process of claim 8, wherein the inclination is such that, on completion of an extrusion stroke, a flow of suspension for filling the extrusion chamber in step (a) for a next stroke, or part of a stroke, cleans the leading face of the piston.

10. The process of claim 9, wherein filling of the extrusion chamber in each step (a) causes or assists in movement of the piston to a retracted position.

11. The process of any one of claims 1 to 10, wherein the pressure at which step (a) is conducted is less than 20 bar.

12. The process of claim 11, wherein the pressure is less than 10 bar.

13. The process of any one of claims 1 to 12, wherein the pressure applied to the suspension in step (b) is from 80 to 240 bar.

14. The process of claim 13, wherein the pressure applied is from 100 to 180 bar.

15. An apparatus for use in the extrusion of a green body from a paste or suspension of particulate material in a liquid (herein referred to collectively as a “suspension”), wherein the apparatus includes:
an extrusion chamber,
a moulding space with a dewatering section defined by at least partially liquid-permeable walls;
means for supplying the suspension to and substantially filling the extrusion chamber at a relatively low pressure; and
means for applying a substantially higher pressure to suspension in the extrusion chamber and forcing the suspension from the extrusion chamber and through the moulding space, and thereby remove a substantial part of the liquid by establishing a pressure differential across at least parts of said wall permeable to said liquid to form a non-flowable shaped body of said particulate material and bring the dewatered paste to a final shape for the green body.

16. The apparatus of claim 15, wherein the extrusion chamber has the same principle cross sectional geometry or form as the final product and wherein the apparatus further includes a piston for pressurizing the extrusion chamber, the piston having the same cross sectional geometry as the final product and fitting into the extrusion chamber.

17. The apparatus of claim 15 or claim 16, wherein the extrusion chamber is operable to cause the suspension to experience only cross sectional reductions in flow through the extrusion chamber towards the de-watering section, whereby the formation of dead spots is substantially prevented; and wherein the cross sectional area of the extrusion chamber is larger than the cross-section of the extruded body.

18. The apparatus of claim 17, wherein the extrusion chamber is operable to cause the suspension to undergo a cross section reduction of between 1:2 and 1:10.

19. The apparatus of claim 18, wherein the reduction is from 1:3 and 1:6.

20. The apparatus of any one of claims 15 to 19, wherein the means for supplying the suspension includes at least one inlet port to the extrusion chamber placed at or close to the end of the extrusion chamber through which the suspension is forced by said means for applying high pressure.

21. The apparatus of claim 16, wherein the means for supplying the suspension includes at least one inlet port located where the piston head is positioned on completion of an extrusion stroke and emptying of the extrusion chamber.

22. The apparatus of claim 21, wherein the means for applying a high pressure is applied to the suspension in step (b) by a leading face of the piston head which is inclined with respect to the line of movement of the piston.

23. The apparatus of claim 22, wherein the inclination is such that, on completion of an extrusion stroke, a flow of suspension for filling the extrusion chamber for a next stroke, or part of a stroke, cleans the leading face of the piston.

24. The apparatus of claim 23, wherein the means for supplying the suspension is adjusted to cause or assist in movement of the piston to a retracted position.

25. The apparatus of any one of claims 15 to 24, wherein the supplying means is operable to supply the suspension at a pressure less than 20 bar, such as less than 10 bar.

26. The apparatus of any one of claims 15 to 25, wherein the pressure applying means is operable force the suspension at a pressure of from 80 to 240 bar such as from 100 to 180 bar.
